(19) United States
(12) Patent Application Publication
(10) Pub. No.: US 2010/0117382 A1
(43) Pub. Date: May 13, 2010

(54) Dual function door lock plate with built-in lock opening(s)

(76) Inventor: Kun Yuan Tong, Suwanee, GA (US)

Correspondence Address: Kun Yuan Tong, 2842 Lowe Court, Suwanee, GA, 30024, US

(21) Appl. No.: 12/291,645

(22) Filed: Nov. 12, 2008

(51) Int. Cl. E05B 15/02

(52) U.S. Cl. 292/341.15

(57) ABSTRACT

Dual function door lock plate with built-in lock opening(s) is a door lock plate which has built-in lock opening(s). It is to be fastened onto door jamb to guide door lock pin to slide smoothly into lock hole and its lock opening(s) can be locked by lock piece(s) to prevent door from being opened outside.

### THE BACKGROUND OF THE INVENTION

Some theft can unlock door lock and opens door. Dual function door lock plate with built-in lock opening(s) can be fastened on door jamb and locked with a lock piece to prevent door from being opened outside.

### THE BRIEF SUMMARY OF THE INVENTION

The functions of door lock plate which is fastened on door jamb is to guide door lock pin to slide smoothly into lock hole of door lock plate to close door. Dual function door lock plate with built-in lock opening(s) has additional function of locking door with a lock piece to prevent door from being opened from outside.

### THE DETAILED DESCRIPTION OF THE DRAWINGS

FIG. 1 is a perspective view of various dual function door lock plates with built-in lock opening(s) and lock pieces.

FIG. 2 is a perspective view of dual function door-lock plate with built-in lock openings which has been fastened onto door jamb.

FIG. 3 is a lateral view of dual function door lock plate with built-in lock openings which has been fastened onto door jamb and door is closed.

FIG. 4 is a lateral view of dual function door lock plate with built-in lock openings which has been fastened onto door jamb and is locked with lock piece after door is closed.

FIG. 5 is a lateral view of dual function door lock plate with built-in lock openings which has been fastened onto door jamb and is locked with lock piece after door is closed.

FIG. 6 is a lateral view of dual function door lock plate with built-in lock openings which has been fastened onto door jamb and is locked with lock pieces after door is closed.

### THE DETAILED DESCRIPTION OF THE INVENTION

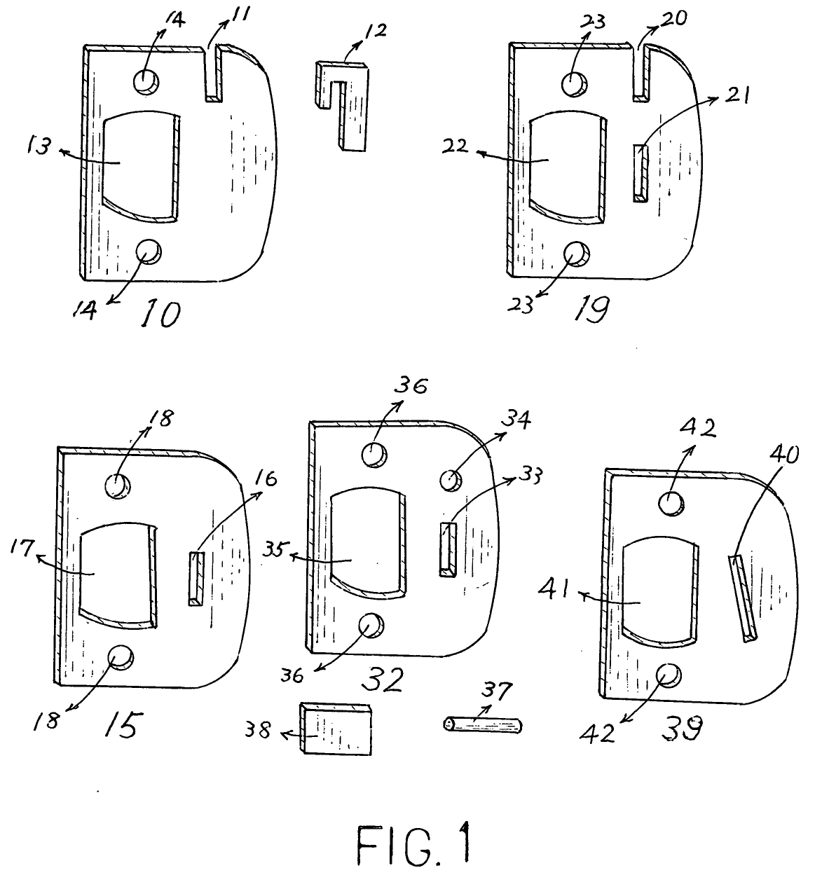

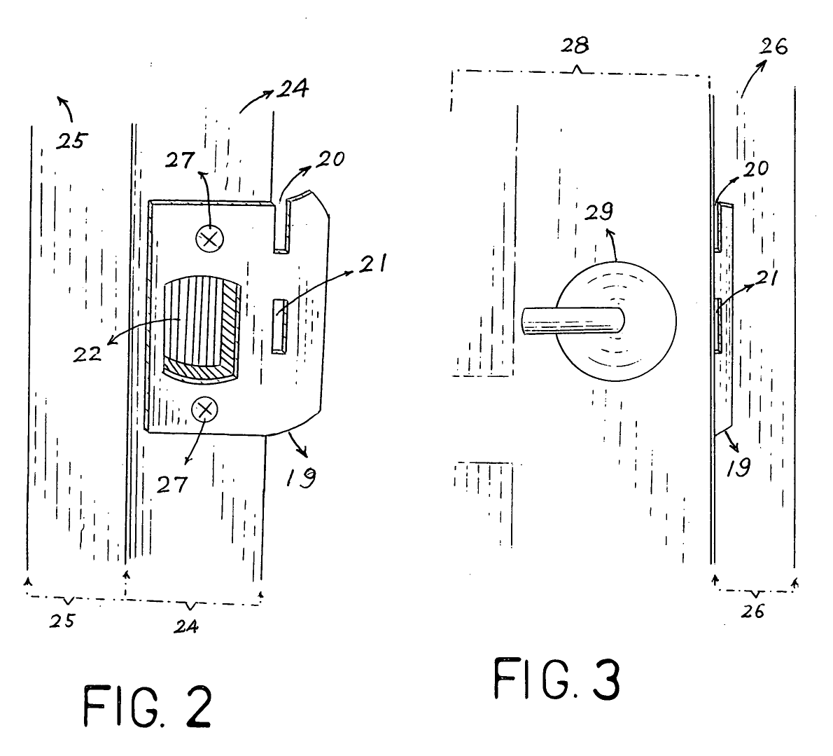

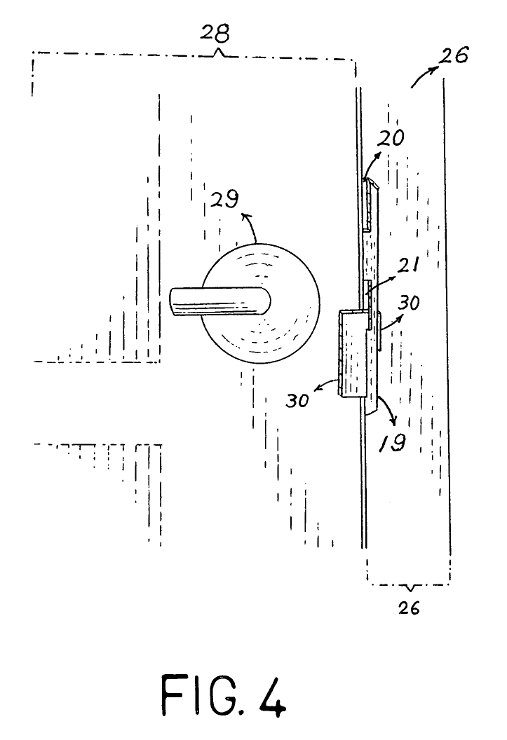

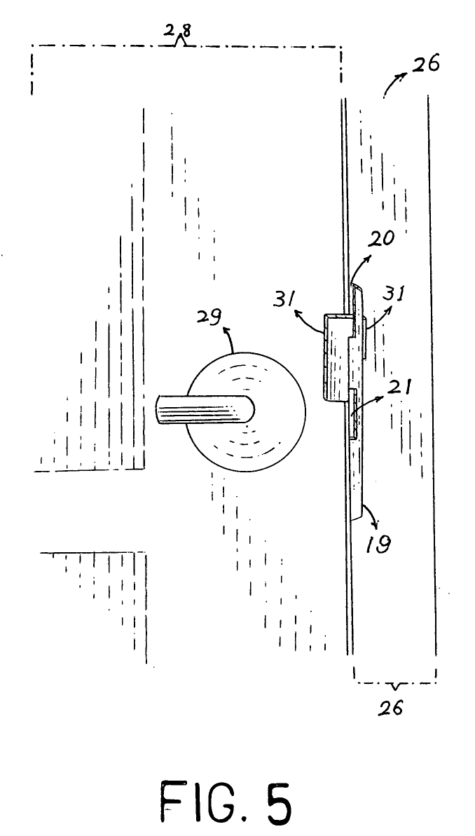

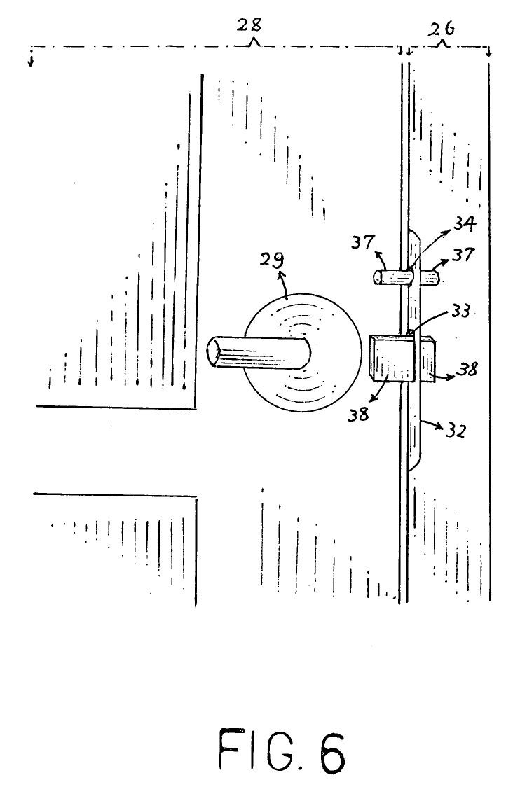

Referring now in detail to the drawings numeral 10 of FIG. 1 is dual function door lock plate with a built-in open lock slot. Now dual function door lock plate with a built-in open lock slot 10 is simplified to be called as dual function door lock plate 10. Numeral 11 of FIG. 1 is built-in open lock slot of dual function door lock plate 10. Numeral 12 of FIG. 1 is lock hook. Numeral 13 of FIG. 1 is lock pin hole of dual function door lock plate 10. Numeral 14 of FIG. 1 is screw hole of dual function door lock plate 10. Numeral 15 of FIG. 1 is dual function door lock plate with a built-in closed lock slot. Now dual function door lock plate with a built-in closed lock slot 15 is simplified to be called as dual function door lock plate 15. Numeral 16 of FIG. 1 is built-in closed lock slot of dual function door lock plate 15. Numeral 17 of FIG. 1 is lock pin hole of dual function door lock plate 15. Numeral 18 of FIG. 1 is screw hole of dual function door lock plate Numeral 19 of FIGS. 1, 2, 3, 4 and 5 is dual function door lock plate with a built-in open lock slot and a built-in closed lock slot. Now dual function door lock plate with a built-in open lock slot and a built-in closed lock slot 19 is simplified to be called as dual function door lock plate 19. Numeral 20 of FIGS. 1, 2, 3, 4 and 5 is built-in open lock slot of dual function door lock plate 19. Numeral 21 of FIGS. 1, 2, 3, 4 and 5 is built-in closed lock slot of dual function doorplate 19. Numeral 22 of FIGS. 1 and 2 is lock pin hole of dual function door lock plate 19. Numeral 23 of FIG. 1 is screw hole of dual function door lock plate 19. Numeral 24 of FIG. 2 is door jamb. Numeral 25 of FIG. 2 is external wall of door jamb 24. Numeral of FIGS. 3, 4, 5 and 6 is internal wall of door jamb 24 of FIG. 2. Numeral 27 of FIG. 2 is screw which has been screwed through screw hole 23 of FIG. 1 to fasten dual function door lock plate 19 of FIG. 1 onto door jamb 24. Numeral 28 of FIGS. 3, 4, 5 and 6 is portion of door. Numeral 29 of FIGS. 3, 4, 5 and 6 is door knob. Numeral 30 of FIG. 4 is lock hook 12 of FIG. 1 which has been inserted into built-in closed lock slot 21 of FIGS. 1, 2, 3, 4 and 5 to prevent door 28 from being opened after door 28 is closed. Numeral 31 of FIG. 5 is lock hook 12 of FIG. 1 which has been inserted into built-in open lock slot 20 of FIGS. 1, 2, 3, 4 and 5 to prevent door 28 from being opened after door is closed. Numeral 32 of FIG. 1 is a dual function door lock plate with a built-in closed slot and a built-in hole. Now dual function door lock plate with built-in closed lock slot and a built-in hole 32 is simplified to be called as dual function door lock plate 32. Numeral 33 of FIGS. 1 and 6 is a close slot of dual function door lock plate 32. Numeral 34 of FIGS. 1 and 6 is hole of dual function door lock plate 32. Numeral 35 of FIG. 1 is door lock pin hole of dual function door lock plate 32. Numeral 36 of FIG. 1 is screw hole of dual function door lock plate 32. Numeral 37 of FIGS. 1 and 6 is lock rod. Lock rod 37 of FIGS. 1 and 6 can be inserted into hole 34 of FIGS. 1 and 6 to prevent door 28 from being opened as illustrated in FIG. 6. Numeral 38 of FIGS. 1 and 6 is lock plate. Lock plate 38 of FIGS. 1 and 6 can be inserted into built-in closed slot 33 of FIGS. 1 and 6 to prevent door 28 from being opened as illustrated in FIG. 6. Numeral 39 of FIG. 1 is dual function door lock plate with an oblique closed slot. Now dual function door lock plate with an oblique closed slot 39 is simplified to be called as dual function door lock plate 39. Numeral 40 of FIG. 1 is oblique closed lock slot of dual function door lock plate 39. Numeral 41 of FIG. 1 is door lock pin hole of dual function door lock plate Numeral 42 of FIG. 1 is screw hole of dual function door lock plate 39. Numeral 26 of FIGS. 3, 4, 5 and 6 is internal wall of door jamb 24 of FIG. 2. The inner sides of open lock slot 11, open lock slot 20, closed lock slot 16, closed lock slot 21, closed lock slot 33, hole 34 and oblique closed lock slot 40 of FIGS. 1, 2, 3, 4, 5 and 6 are at the same plan of internal wall 26 of FIGS. 3, 4 and 5 of door iamb 24 of FIG. 2.

1. Dual function door lock plate comprising a fenestrated door lock plate and lock piece

2. Dual function door lock plate of claim 1 wherein said fenestrated door lock plate of claim 1 has a large central door lock pin hole at one side and opening or openings at the other side. Wherein said opening(s) is(are) built longitudinally or obliquely at the position where whose inner side(s) is (are) at the same plane with the internal wall of door jamb. Wherein said opening(s) can be open slot at the upper end of said door lock plate or closed slot or hole at the middle portion of said door lock plate or both slot(s) and hole.

3. Dual function door lock plate of claim 1 wherein said lock piece of claim is a rectangular plate or a 7-shaped hook or a rod which can be inserted into said opening(s) of claim 2.
